(19) United States
(12) Patent Application Publication
(10) Pub. No.: US 2026/0046359 A1
(43) Pub. Date: Feb. 12, 2026

(54) ROUTING EMERGENCY CALLS BASED ON AUTHENTICATION ABILITY OF PUBLIC SAFETY ANSWERING POINTS

(71) Applicant: T-MOBILE INNOVATIONS LLC, Overland Park, KS (US)

(72) Inventors: Hilah Anne ROZIER, Lenexa, KS (US); Dinko Gerogiev DINKOV, Kirkland, WA (US); Khurram Ahmad MIRZA, Redmond, WA (US); Srinivasa Rao BODAPOTULA, Bellevue, WA (US)

(21) Appl. No.: 18/797,229

(22) Filed: Aug. 7, 2024

(51) Int. Cl. H04M 3/51; H04M 3/42

(52) U.S. Cl. CPC H04M 3/5116; H04M 3/42059; H04M 3/42348

(57) ABSTRACT

Systems and methods are provided for reducing delays associated with emergency calls. An emergency NF requests location information associated with an emergency call. The emergency NF receives a modified emergency services routing number (ESRN) comprising a traffic path identifier. Based on the traffic path identifier, an invite message associated with the emergency call is routed to a first realm or a second realm. The first realm may be associated with one or more authentication-enabled PSAPs and the second realm may be associated with one or more non-authentication-enabled PSAPs. At the first realm, a routing NF will wait for an authentication response, and at the second realm, the routing NF will not wait for an authentication response, reducing unnecessary delay of the emergency call.

### SUMMARY

The present disclosure is directed, in part to routing an invite message of an emergency call to a first realm or a second realm, substantially as shown and/or described in connection with at least one of the figures, and as set forth more completely in the claims.

According to various aspects of the technology, emergency calling is an important aspect of telecommunications systems. Fast call setup and data transmission enable prompt reporting of emergencies, quick deployment of resources, and effective coordination of emergency responses. Conventionally, an emergency call may be communicated through a core network before reaching a public safety answering point (PSAP). As an emergency call travels through a network, authentication information may be added to the emergency call to allow authentication of the emergency call. However, some PSAPs are unable to process this authentication information, and thus any time spent authenticating the emergency call is an inefficient use of valuable time. Waiting for authentication of the emergency call when the PSAP will not use this information may unnecessarily prolong the wait period of the subscriber who initiated the emergency call. By segmenting emergency calls into a first realm associated with authentication-enabled PSAPs or a second realm associated with non-authentication-enabled PSAPs, emergency calls routed to non-authentication-enabled PSAPs will not unnecessarily wait for an authentication response, reducing the overall call setup time and improving emergency response outcomes.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary method for directing an emergency call to a first realm or a second realm in which implementations of the present disclosure may be employed; and

FIG. 4 illustrates a flow diagram of an exemplary method for directing an emergency call to a first realm or a second realm in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, network efficiency is critical for swift communication in emergency call scenarios. Fast call setup and data transmission enable prompt reporting of emergencies, quick deployment of resources, and effective coordination of emergency responses. High-speed, efficient networks ensure reliable and continuous communication during these critical emergency situations. Systems and methods improving such high-speed communication and efficient operation of networks may reduce delays associated with an emergency call traveling through a network, resulting in improved emergency response outcomes and additional lives saved.

Conventionally, an emergency call may be communicated through a core network before reaching a public safety answering point (PSAP). When an emergency call travels through a network, authentication information may be added to the emergency call to authenticate the emergency call. However, some PSAPs are unable to process this authentication information, and thus any time spent authenticating is an inefficient use of valuable time. The delay caused by waiting for authentication of the emergency call when the PSAP will not use this information may prolong the wait period of the subscriber who initiated the emergency call. The resulting emergency call may be delayed and negatively impact emergency response outcomes.

In contrast to conventional solutions, the present disclosure is directed to providing a traffic path identifier to indicate that emergency calls should be routed to either authentication-enabled PSAPs or non-authentication-enabled PSAPs such that calls routed to non-authentication-enabled PSAPs do not unnecessarily wait for an authentication response before being transmitted to the PSAP. The traffic path identifier may indicate whether an emergency call is to enter a first realm or a second realm prior to transmission to the PSAP. The first realm receives emergency calls to be routed to PSAPs that are authentication enabled and will thus wait for an authentication response. The second realm receives emergency calls to be routed to non-authentication-enabled PSAPs, allowing these emergency calls to skip the wait and proceed to the non-authentication-enabled PSAP without waiting for an authentication response. By segmenting emergency calls into the first and second realms, emergency calls being routed to non-authentication-enabled PSAPs will not unnecessarily wait for an authentication response, reducing the overall call setup time and improving emergency response outcomes.

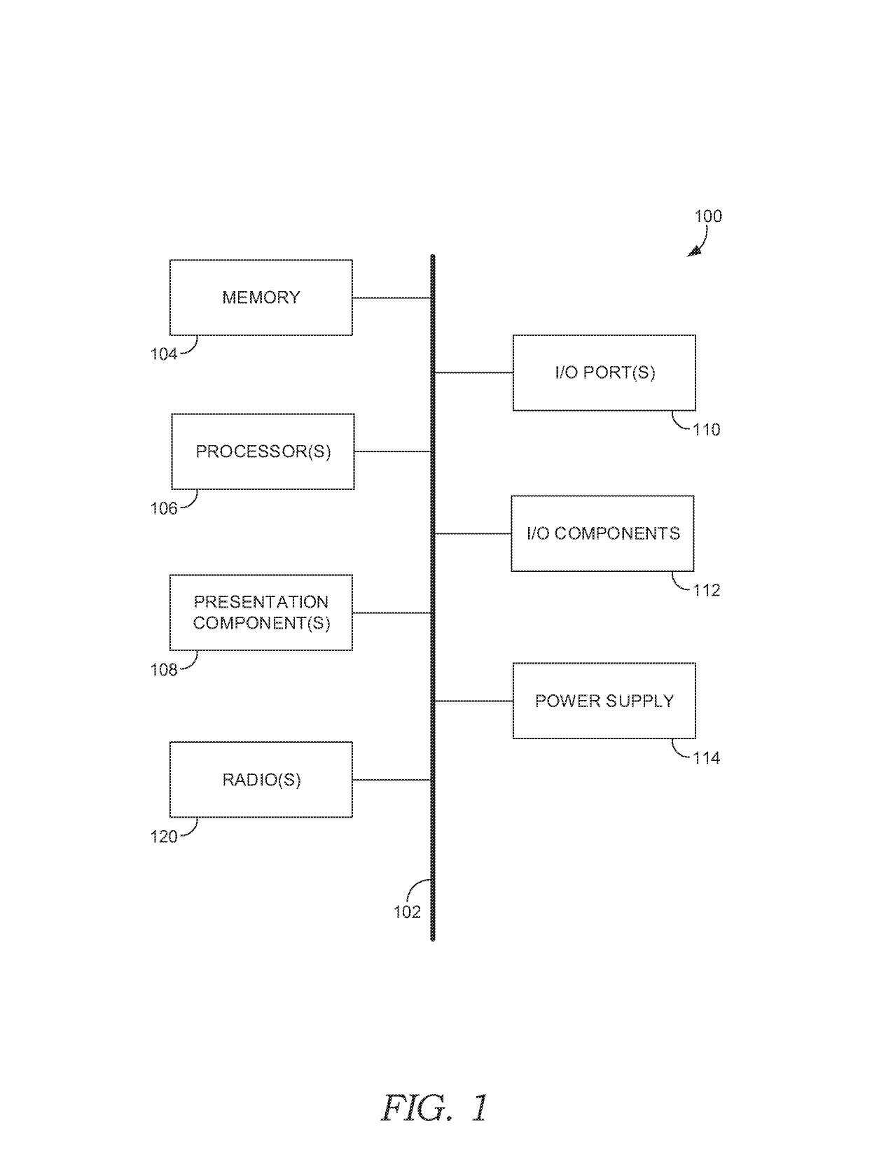

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

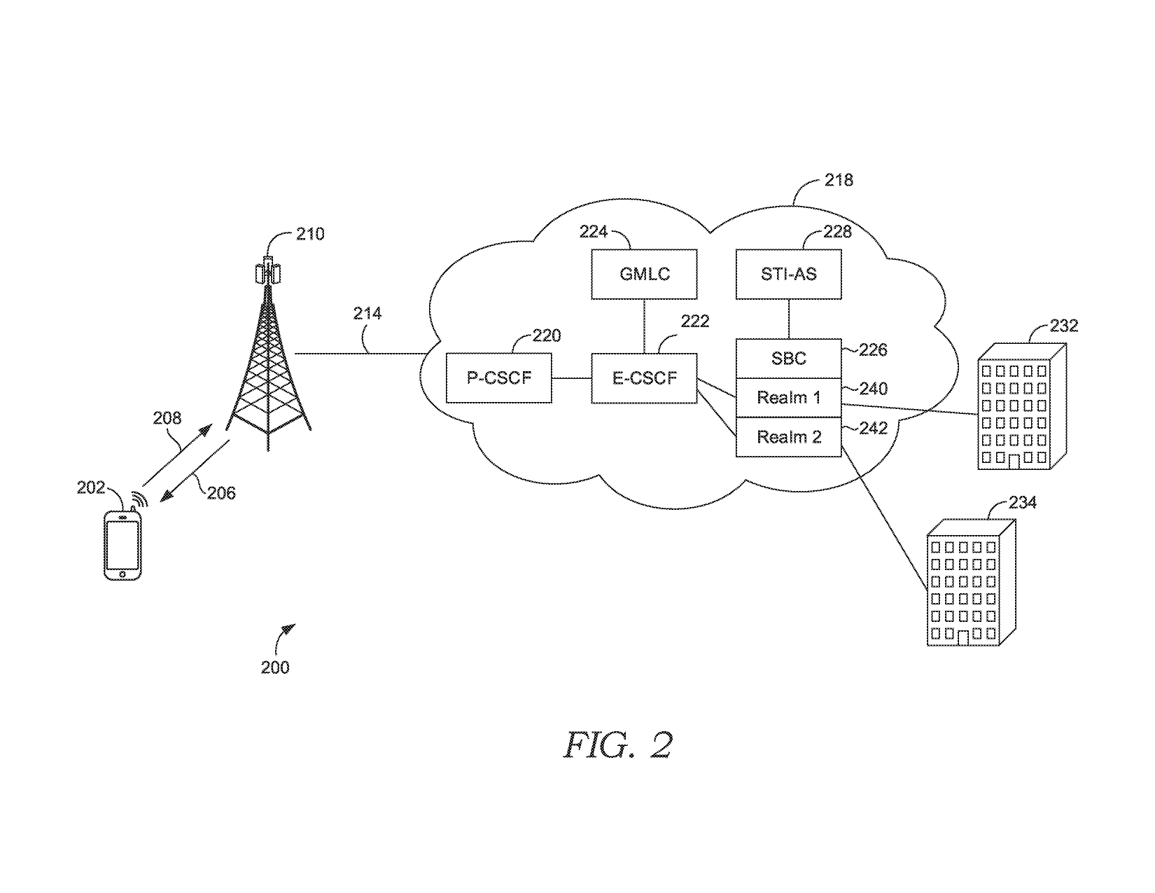

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as a UE 202, one or more base stations, such as a base station 210, a core network 218, a proxy-call session control function (P-CSCF) 220, an emergency-call session control function (E-CSCF) 222, a gateway mobile location center (GMLC) 224, a session border controller (SBC) 226, a secure telephone identity authentication service (STI-AS) 228, one or more authentication-enabled public safety answering points (PSAP) (e.g., a authentication-enabled PSAP 232), and one or more non-authentication-enabled PSAPs (e.g., a non-authentication-enabled PSAP 234), though in some implementations, it may not be necessary for certain features to be present. The network environment may include a number of routers, switches, and the like. The network environment 200 is generally configured for wirelessly connecting the UE 202 to data or services that may be accessible on one or more application servers or other functions, nodes, or servers not pictured in FIG. 2 so as to not obscure the focus on the present disclosure. In aspects, the network environment 200 is at least partially configured to operate using a signature-based handling of asserted information using tokens (SHAKEN) framework.

The network environment 200 comprises the UE 202. The UE 202 is illustrated generally, and may take any number of forms, including a tablet, phone, or wearable device, or any other device discussed with respect to FIG. 1 and may have any one or more components or features of the computing device 100 of FIG. 1. The UE 202 may be configured to make an emergency call to an emergency services number (e.g., 911). In aspects, the UE 202 may not be a conventional telecommunications devices, but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the base station 210 to which the UE 202 may potentially connect to (also referred to as ‘camping on,’ ‘attaching,’ in the industry). Though network environment 200 is illustrated with one base station 210, one skilled in the art will appreciate that more or fewer base stations may be present in any particular network environment. The base station 210 of the network environment 200 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The base station 210 is configured to communicate with one or more UEs, such as the UE 202. The base station 210 may communicate signals to one or more UEs via a downlink 206 and receive signals from one or more UEs via uplink 208. In response to receiving certain requests to and/or from the UE 202, the base station 210 may communicate with the core network 218 via a backhaul 214. For example, in order for the UE 202 to connect to a desired network service (e.g., PSTN call, voice over LTE (VoLTE) call, voice over new radio (VoNR), data, or the like), the UE 202 may communicate an attach request to the base station 210, which may, in response, communicate a registration request to the core network 218 via the backhaul 214.

The core network 218 may comprise one or more network functions (NFs). As used herein, the term “network function” is used to describe a computer processing module and/or one or more computer executable services being executed on one or more computing processing modules. In aspects, the core network 218 is an IP Multimedia Subsystem (IMS) network. The core network 218 may comprise NFs that include any one or more of the P-CSCF 220, the E-CSCF 222, the GMLC 224, the SBC 226, and the STI-AS 228. Each of the preceding NFs may take different forms, including consolidated or distributed forms that perform the same general operations. In other architectures or protocols, the NFs may be given other names, however, the NFs herein refer to functions, not specifically identified components.

Though the P-CSCF 220, the E-CSCF 222, the GMLC 224, the SBC 226, and the STI-AS 228 are illustrated in the core network 218, the core network 218 may have more or fewer NFs than shown. For example, the core network 218 may include an access and mobility management function (AMF), a mobility management entity (MME), a home subscriber service (HSS) and the like. Further, though the P-CSCF 220, the E-CSCF 222, the GMLC 224, the SBC 226, and the STI-AS 228 are illustrated as disposed within the core network 218, it is expressly contemplated that the location in the network environment 200 is non-limiting. For example, the NFs described above may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above. For example, in some aspects, there may be more than one SBC 226.

The core network 218 is a service-based architecture and contains NFs defined by their function. The P-CSCF 220, for example, is generally responsible for providing an entry point for a message from a UE (e.g., the UE 202) requesting services from a network (e.g., an IMS network). The E-CSCF 222, for example, is generally responsible for assisting in routing emergency calls to an appropriate destination, such as a PSAP. The GMLC 224, for example, is generally responsible for providing location information to the E-CSCF 222 to aid in routing an emergency call. The SBC 226, for example, is generally responsible for providing access and security at a connection point or border of the core network 218. The STI-AS 228, for example, is generally responsible for authenticating sessions at the border of the core network 218 (e.g., prior to session handoff to a PSAP by the SBC 226). Each of these NFs may communicate with each other, directly or indirectly, via interfaces existing between them. For example, the E-CSCF 222 may communicate with the GMLC 224 to obtain location information to route an emergency call.

The P-CSCF 220 may perform various functions relating to emergency calling. For example, the P-CSCF 200 may process incoming invite messages from the UE 202 (e.g., SIP INVITE messages), add one or more authentication headers to invite messages, and route messages to the E-CSCF 222. For example, the P-CSCF 220 may add a priority header, such as a resource priority header (“resource-priority”), to an incoming invite message from the UE 202. In aspects, the invite message may be modified by the P-CSCF 220 to include the one or more authentication headers such as “attestation-info,” “origination-ID,” and the like.

The E-CSCF 222 may perform various functions relevant to emergency calling. For example, the E-CSCF 222 may receive invite messages from the P-CSCF 220, request location information in order to properly route the invite message, and may route the invite message to the SBC 226 for routing to one or more PSAPs. In some aspects, the E-CSCF 222 receives an invite message from the P-CSCF 220 which includes the one or more authentication headers. The E-CSCF 222 may request the GMLC 224 for the location of the caller, a time stamp, a caller identity, and/or an emergency services routing number (ESRN) associated with the invite message.

The GMLC 224 may perform functions relevant to emergency calling such as providing location information to NFs (e.g., the E-CSCF 222) in a location response. Location information may include any one or more of the location of the caller (e.g., latitude and longitude, GPS position, serving cell location, civic address), accuracy of the location of the caller, the time stamp of the emergency call, the caller identity, and/or the ESRN. In some aspects, the GMLC 224 may obtain some of or all of this location information from another NF and/or from a database within the GMLC 224 or in communication with the GMLC 224. In other aspects, the GMLC 224 may obtain the location of the caller using various methods such as GPS, cell tower triangulation, Wi-Fi positioning, and the like. In aspects, the GMLC 224 communicates the location response including at least some of the location information to the E-CSCF 222.

The SBC 226 may perform functions relevant to emergency calling. For example, the SBC 226 may provide security at the network border, preventing malicious attacks or unauthorized access of the core network 218. The SBC 226 may receive the invite message from the E-CSCF 222, and the SBC 226 may submit the invite message to the STI-AS 228 for authentication. In such aspects, the SBC 226 receives an authentication response (e.g., SIP 302 message, an authenticated invite message) including an authenticated caller identity token from the STI-AS 228 (e.g., a personal assertion token (PASSporT)). After authentication, the SBC 226 may directly send the invite message to one of the authentication-enabled PSAP 232 or the non-authentication-enabled PSAP 234, and in other aspects, the SBC 226 sends the emergency call to one or more peering partner SBC(s) and the peering partner SBC(s) may route the emergency call to a designated PSAP (e.g., the authentication-enabled PSAP 232 or the non-authentication-enabled PSAP 234). In such aspects, the peering partner SBC may be an interconnect SBC (I-SBC). In some aspects, the SBC 226 may be an interconnect SBC (I-SBC).

The STI-AS 228 may perform functions relevant to emergency calling, such as authenticating the invite message and providing the authenticated caller identity token. In aspects, the SBC 226 may submit the invite message to the STI-AS 228 for authentication. The STI-AS 228 responds with the authentication response, which may include the authenticated caller identity token (e.g., where the emergency call is authentic) or an indication of failed authentication (e.g., where the emergency call is not authentic). In some aspects, the authenticated caller identity token is a PASSporT associated with the SHAKEN framework. In other aspects, the authenticated caller identity token may take another form (e.g., certificate, token, shared secret keys, one-time passwords, and the like). The STI-AS 228 may communicate the authentication response (e.g., a SIP 302 message) to the SBC 226.

One or more authentication-enabled PSAPs (e.g., the authentication-enabled PSAP 232) and one or more non-authentication-enabled PSAPs (e.g., the non-authentication-enabled PSAP 234) are present in the network environment 200 and may receive the invite message from the SBC 226 (or a peering partner SBC in communication with the SBC 226). A PSAP is generally responsible for receiving emergency calls, gathering information, and dispatching emergency services such as fire, EMS, and/or police. In aspects, the authentication-enabled PSAP 232 is configured to process the authenticated caller identity token, and the non-authentication-enabled PSAP 234 is not configured to process the authenticated caller identity token.

Relevant to the present disclosure, and as briefly described above, some PSAPs that receive emergency calls are non-authentication-enabled PSAPs (e.g., the non-authentication-enabled PSAP 234) and cannot process the authenticated caller identity token. Conventionally, the SBC 226 will indiscriminately submit the invite message to the STI-AS 228 for authentication. The SBC 226 will wait for the authentication response from the STI-AS 228, even when the emergency call will not be routed to the authentication-enabled PSAP 232. Thus, emergency calls that are to be routed to the non-authentication-enabled PSAP 234 are delayed by the wait time at the SBC 226, even though the non-authentication-enabled PSAP 234 cannot process the authenticated caller identity token. Any time the SBC 226 spends waiting on the authentication response creates an unnecessary delay for emergency calls being routed to non-authentication-enabled PSAPs (e.g., the non-authentication-enabled PSAP 234). To eliminate this unnecessary delay, emergency calls may be segmented into separate realms or separate SBCs such that emergency calls destined for non-authentication-enabled PSAPs will not unnecessarily wait for a response from the STI-AS 228.

In response from a request from one or more NFs (e.g., the E-CSCF 222) for the location information of the caller, the GMLC 224 provides the location response. In aspects, the location response is a modified version of the invite message received by the E-CSCF 222, generating a location-modified invite message, and in other aspects, the location response is a message distinct from the invite message associated with the emergency call (e.g. a SIP 300 response). The GMLC 224, as described above, identifies or is made aware of the location of the caller associated with the emergency call, as well as other location information. Based on this location information, the GMLC 224 may determine which PSAP the emergency call should be routed to, based on the caller’s location. In some aspects, the GMLC 224 accesses a PSAP database that includes information regarding whether the relevant PSAP is authentication-enabled or non-authentication-enabled, and in other aspects, this information is obtained from another NF.

The GMLC 224 may notify the E-CSCF 222 in various ways on whether the emergency call is going to be routed to an authentication-enabled PSAP (e.g., the authentication-enabled PSAP 232) or a non-authentication-enabled PSAP (e.g., the non-authentication-enabled PSAP 234). In aspects, the GMLC 224 may add an authentication flag to the location response to be received by the E-CSCF 222. In some aspects, the GMLC 224 does not add the authentication flag when the emergency call is to be routed to a non-authentication-enabled PSAP but does add the authentication flag when the emergency call is to be routed to an authentication-enabled PSAP. In other aspects, the authentication flag may have one value when the emergency call will be routed to an authentication-enabled PSAP and the authentication flag may have another value when the emergency call will be routed to a non-authentication-enabled PSAP. The authentication flag may take many forms, such as a binary flag, enumerated value, a text string, and the like.

In aspects, the GMLC 224 provides a traffic path identifier to the E-CSCF 222. In some aspects, the GMLC 224 may modify one or more identifiers associated with the emergency call (e.g., the emergency services routing number (ESRN), a timestamp, a subscriber identifier, a session identifier, and the like) to include the traffic path identifier. In other aspects, the GMLC 224 may provide the traffic path identifier as a standalone identifier. The traffic path identifier may inform NFs (e.g., the E-CSCF 222) whether the invite message should be sent to a first realm 240 of the SBC 226, associated with one or more authentication-enabled PSAPs (e.g., the authentication-enabled PSAP 232), or a second realm 242 of the SBC 226, associated with one or more non-authentication-enabled PSAPs (e.g., the non-authentication-enabled PSAP 234). As used herein, a “realm” is a domain used to segment network traffic according to one or more rules (e.g., the value of the traffic path identifier).

An original ESRN associated with the emergency call may be modified by the GMLC 224 to include the traffic path identifier. The traffic path identifier may have one value when the emergency call will be routed to an authentication-enabled PSAP (e.g., the authentication-enabled PSAP 232) and the traffic path identifier may have another value when the emergency call will be routed to a non-authentication-enabled PSAP (e.g., the non-authentication-enabled PSAP 234). In aspects, the traffic path identifier is a prefix added to the beginning of the identifier (e.g., the ESRN) associated with the emergency call, and in other aspects, the traffic path identifier added to the middle or the end of the identifier associated with the emergency call. The traffic path identifier may be a numerical value, a text string, or a combination of these. In aspects, the GMLC 224 may communicate the traffic path identifier to the E-CSCF 222 in the location response.

In some aspects, based on the authentication flag and/or the lack thereof, the E-CSCF 222 may remove the one or more authentication headers from the invite message. For example, in aspects where the authentication flag is not present in the location response when the emergency call is to be routed to a non-authentication-enabled PSAP (e.g., the non-authentication-enabled PSAP 234), the missing authentication flag signals to the E-CSCF 222 to remove the one or more authentication headers from the invite message. In aspects where the authentication flag is present in the location response and its value indicates the emergency call is to be routed to a non-authentication-enabled PSAP (e.g., the non-authentication-enabled PSAP 234), the value of the authentication flag signals to the E-CSCF 222 to remove the one or more authentication headers. Advantageously, removing the one or more authentication headers eliminates the possibility of error in downstream communications regarding the emergency call, as non-authentication-enabled PSAPs (e.g., the non-authentication-enabled PSAP 234) are unable to process the one or more authentication headers.

Based on the traffic path identifier, the E-CSCF 222 may route the invite message to the SBC 226. In some aspects, the SBC 226 comprises both the first realm 240 and the second realm 242, and in other aspects, the first realm 240 and the second realm 242 are located on separate SBCs. The E-CSCF 222 may route the invite message to the first realm 240 when the traffic path identifier indicates the emergency call will be routed to an authentication-enabled PSAP (e.g., the authentication-enabled PSAP 232), and the E-CSCF 222 may route the invite message to the second realm 242 when the traffic path identifier indicates the emergency call will be routed to a non-authentication-enabled PSAP (e.g., the non-authentication-enabled PSAP 234).

The first realm 240 and/or the SBC 226 may be configured such that invite messages routed to the first realm 240 will be routed to the STI-AS 228 and the SBC 226 will wait for the authentication response from the STI-AS 228 prior to being routed to the peering partner SBC and/or an authentication-enabled PSAP (e.g., the authentication-enabled PSAP 232). For example, the invite message associated with the emergency call will be routed to the STI-AS 228, and the SBC 226 will wait for the STI-AS 228 to provide the authentication response including the authenticated caller identity token, based on the invite message being routed to the first realm 240.

The second realm 242 and/or the SBC 226 may be configured such that invite messages routed to the second realm 242 will be routed to the STI-AS 228 and will not wait for the authentication response from the STI-AS 228. For example, the invite message associated with the emergency call will be routed to the STI-AS 228, and the SBC 226 will not wait for the STI-AS 228 to provide the authentication response including the authenticated caller identity token, based on the invite message being routed to the second realm 242. In other aspects, the second realm 242 and/or the SBC 226 may be configured to not communicate with the STI-AS 228 at all, and instead, will not route the invite to the STI-AS 228 and therefore will not wait for authentication by the STI-AS 228. For example, the invite message may be routed to the second realm 242 and then may be directly routed to the non-authentication-enabled PSAP 234 or indirectly routed to the non-authentication-enabled PSAP 234 via a peering partner SBC, without submitting the invite message to the STI-AS 228 or waiting for the authentication response from the STI-AS 228.

Advantageously, by separating the emergency call invite message traffic into the first realm 240 and the second realm 242, one or more network operators may separately monitor traffic in the first realm 240 and traffic in the second realm 242. Such separation enables network operators to designate one or more specific interfaces or monitoring systems associated with the first realm and/or the second realm. In aspects, network operators may monitor the call success rate, call delays, false processing delays, generated errors, post-dial delay (PDD), and/or other key performance indicators (KPIs) associated with emergency calls and/or non-emergency calls (i.e., regular voice calls) in either of the first realm or the second realm.

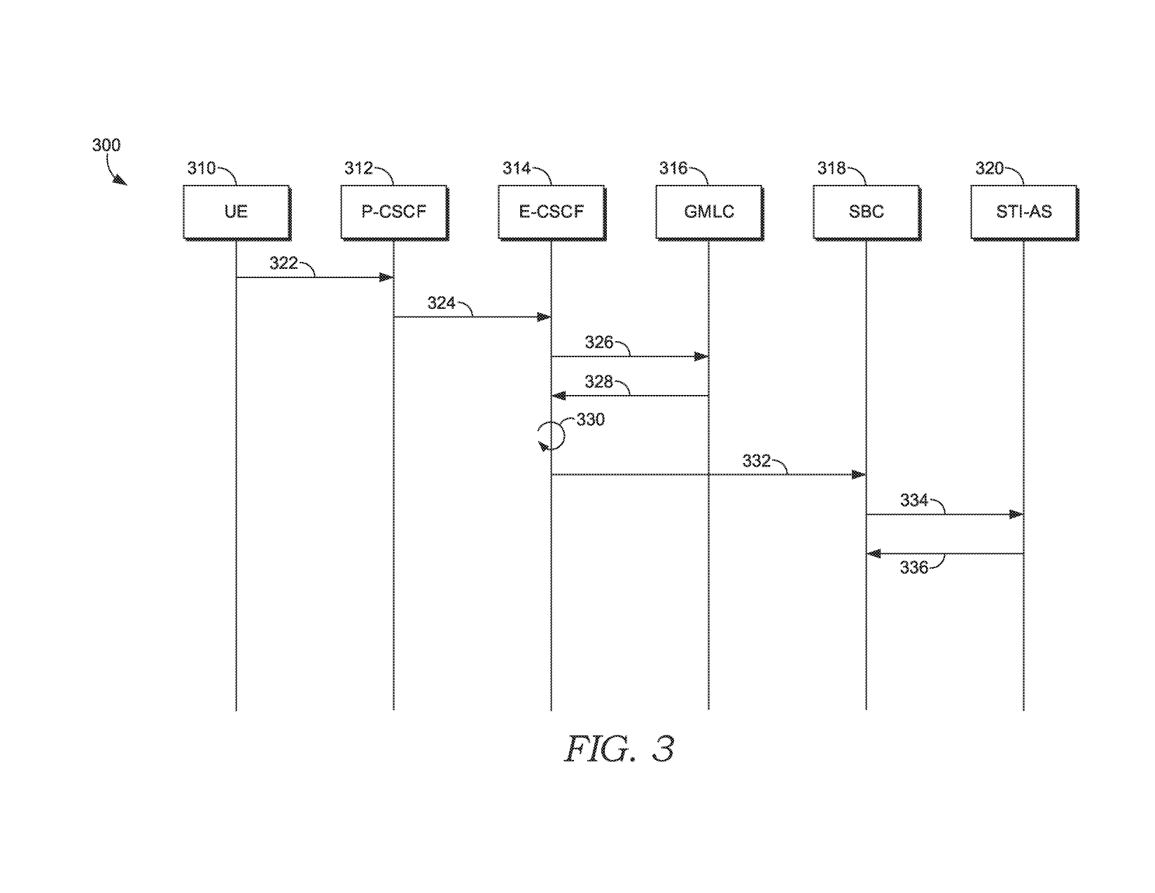

Turning now to FIG. 3, a call flow diagram is illustrated in accordance with one or more aspects of the present disclosure. A call flow 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs. The call flow 300 may generally include a UE 310 (e.g., the UE 202 of FIG. 2), a P-CSCF 312 (e.g., the P-CSCF 220 of FIG. 2), an E-CSCF 314 (e.g., the E-CSCF 222 of FIG. 2), a GMLC 316 (e.g., the GMLC 224 of FIG. 2), an SBC 318 (e.g., the SBC 226 of FIG. 2), and an STI-AS (e.g., the STI-AS 228 of FIG. 2). Each of the preceding NFs may take different forms, including consolidated or distributed forms that perform the same general operations. In other architectures or protocols, the NFs may be given other names, however, the NFs herein refer to functions, not specifically identified components. The call flow 300 may include one or more aspects described with respect to FIG. 2.

At a first step 322, the UE 310 communicates an invite message associated with an emergency call to the P-CSCF 312. For example, the UE 310 makes an emergency call to obtain emergency services such as police, fire, rescue, etc. At the P-CSCF 312, the invite message may be modified to include one or more authentication headers, as described with respect to FIG. 2. At a second step 324, the P-CSCF 312 communicates the invite message to the E-CSCF 314, as described with respect to FIG. 2.

At a third step 326, the E-CSCF 314 requests location information from the GMLC 316, as described with respect to FIG. 2. In some aspects, the request is communicated by the E-CSCF 314 communicating the invite message to the GMLC 316, and in other aspects, the request is communicated to the GMLC 316 as a distinct message from the invite message. In aspects where the request is a distinct message, the request for location information may be configured according to one or more protocols such as diameter, SIP, JSON, HTTP/2, and the like. In some aspects, the request for location information may include one or more caller identifiers such as an international mobile subscriber identity (IMSI), a mobile station international subscriber directory number (MSISDN), a caller line identification, and the like, to aid the GMLC 316 in finding the location information associated with the caller of the emergency call.

At a fourth step 328, the GMLC 316 responds to the request for location information by providing the location information associated with the caller (e.g., based on one or more caller identifiers) to the E-CSCF 314 in a location response, as described with respect to FIG. 2. In aspects, the location response is a SIP 300 message. The GMLC 316 may use the location information and knowledge of available PSAPs to determine whether the emergency call will be routed to an authentication-enabled PSAP (e.g., the authentication-enabled PSAP 232 of FIG. 2) or a non-authentication-enabled PSAP (e.g., the non-authentication-enabled PSAP 234 of FIG. 2). In aspects, the GMLC 316 may modify an original ESRN associated with the emergency call to provide a modified ESRN including a traffic path identifier to the E-CSCF 314, as described with respect to FIG. 2. The value of the traffic path identifier may be based on whether the emergency call will be routed to an authentication-enabled PSAP or a non-authentication-enabled PSAP, as described with respect to FIG. 2. The GMLC 316 may provide an authentication flag in the location response to indicate whether the E-CSCF 314 should retain the one or more authentication headers, as described with respect to FIG. 2.

At a fifth step 330, the E-CSCF 314 exercises logic to modify the invite message based on the location response. In some aspects, the E-CSCF 314 may remove the one or more authentication headers from the invite message based on the authentication flag or lack thereof, as described with respect to FIG. 2. In other aspects, the E-CSCF 314 may remove the one or more authentication headers based on the modified ESRN (i.e., the traffic path identifier of the modified ESRN) provided by the GMLC 316. The E-CSCF 314 may analyze the modified ESRN (e.g., the traffic path identifier of the ESRN) to determine which realm and/or which SBC to route the invite message.

At a sixth step 332, the E-CSCF 314 communicates the invite message to the SBC 318. In some aspects, the SBC 318 is segmented into a first realm (e.g., the first realm 240 of FIG. 2) and a second realm (e.g., the second realm 242 of FIG. 2), and in other aspects, the SBC 318 may be one or more SBCs, with separate SBCs being associated with the first realm or the second realm, as described with respect to FIG. 2. Based on the modified ESRN (e.g., the traffic path identifier of the modified ESRN), the E-CSCF 314 communicates the invite message (e.g., with or without the one or more authentication headers, as described above) to either of the first realm or the second realm of the SBC 318 (or to a first realm associated with a first SBC or to a second realm associated with a second SBC).

At a seventh step 334, the SBC 318 communicates the invite message to the STI-AS 320 for authentication, such as to receive an authentication response including an authenticated caller identity token, as described with respect to FIG. 2. For invite messages in the first realm, the SBC 318 will wait for an authentication response (e.g., the authenticated caller identity token) from the STI-AS 320. In aspects, the SBC 318 will wait up to 100 milliseconds (ms), up to 250 ms, and/or up to 500 ms for the authentication response including the authenticated caller identity token. For invite messages in the second realm, the SBC 318 will not wait for the authentication response from the STI-AS 320, as described with respect to FIG. 2. Instead, invite messages in the second realm may be communicated to the relevant non-authentication-enabled PSAP (e.g., the non-authentication-enabled PSAP 234 of FIG. 2) without the one or more authentication headers, without the authenticated caller identity token, and without substantial delay from waiting for the authentication response.

In some aspects, at an eighth step 336, the SBC 318 receives the authentication response from the STI-AS 320. For invite messages in the first realm, the SBC 318 receives the authentication response, which contains the authenticated caller identity token. Upon receiving the authentication response, the SBC 318 may route the authenticated invite message, including the authenticated caller identity token, to a peering partner SBC and/or to the relevant PSAP (e.g., the authentication-enabled PSAP 232 of FIG. 2). For invite messages in the second realm, the SBC 318 may receive the authentication response after the invite message has been communicated to the peering partner SBC and/or the relevant PSAP (e.g., the non-authentication-enabled PSAP 234 of FIG. 2). In some aspects, the authentication response for invite messages in the second realm may have different features than the authentication response for invite messages in the first realm. For example, the authentication response for the invite message in the second realm may include a ‘no verification’ indicator or an error message. In other aspects, the authentication response for invite messages in the second realm may have the same features as the authentication responses for invite messages in the first realm. Although the SBC 318 may eventually receive the authentication response for invite messages in the second realm, the SBC 318 does not wait for the authentication response prior to routing the unauthenticated invite message to a non-authentication-enabled PSAP.

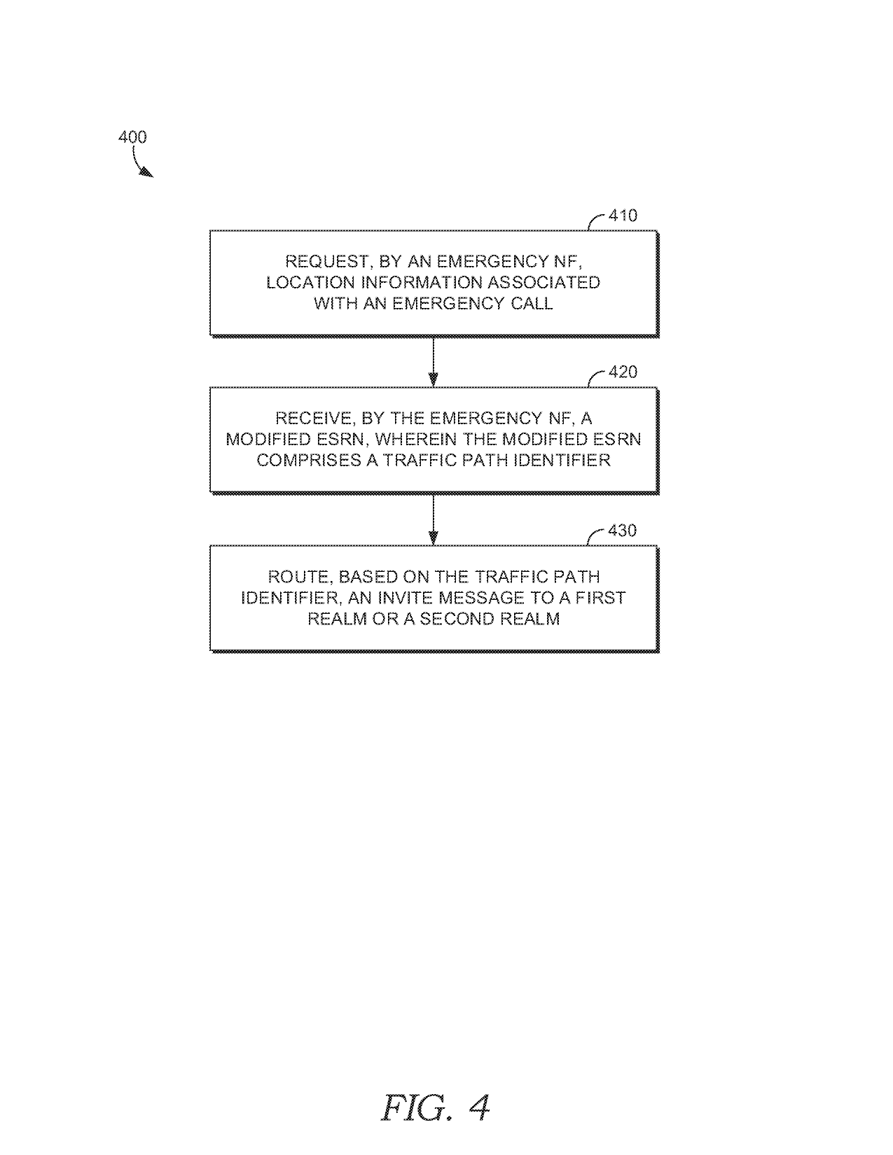

Turning now to FIG. 4, a flow chart is provided that illustrates one or more aspects of the present disclosure relating to a method 400 for directing an invite message of an emergency call to a first realm or a second realm. The method 400 may include one or more aspects described with respect to FIGS. 1-3.

At a first step 410, an emergency NF requests location information associated with an emergency call. In aspects, the emergency NF is an E-CSCF (e.g., the E-CSCF 222 of FIG. 2, the E-CSCF 314 of FIG. 3). The emergency NF may request the location information from a location NF, such as the GMLC (e.g., the GMLC 224 of FIG. 2, the GMLC 316 of FIG. 3).

At a second step 420, the emergency NF receives a modified emergency services routing number (ESRN) associated with an emergency call. An ESRN associated with an emergency call may be modified by the location NF, as described with respect to FIGS. 2-3. In aspects, the modified ESRN comprises a traffic path identifier. The emergency NF (e.g., the E-CSCF) may receive the modified ESRN from the location NF (e.g., the GMLC). In some aspects, the emergency NF may additionally receive an authentication flag, which may indicate the emergency NF should retain one or more authentication headers from the invite message (e.g., where the invite message is to be routed to an authentication-enabled PSAP), as described with respect to FIGS. 2-3.

At a third step 430, the invite message associated with the emergency call is routed to a first realm or a second realm, based on the traffic path identifier. In aspects, the traffic path identifier is a prefix of the modified ESRN, and the value of the prefix indicates whether the invite message is to be routed to the first realm or the second realm. When the traffic path identifier indicates the first realm, the invite message is routed to the first realm, and based on the invite message’s presence in the first realm, a routing NF will wait for an authentication response from an authenticating NF. The authentication response may include an authenticated caller identity token, as described with respect to FIGS. 2-3. When the traffic path identifier indicates the second realm, the invite message is routed to the second realm, and based on the invite message’s presence in the second realm, the routing NF will not wait for the authentication response from the authenticating NF. In some aspects, the routing NF is a single component including both the first realm and the second realm, and in other aspects, there are at least two routing NFs, with each associated with the first realm or the second realm. In aspects, the routing NF is a SBC (e.g., the SBC 226 of FIG. 2, the SBC 318 of FIG. 3), and the authenticating NF is a STI-AS (e.g., the STI-AS 228 of FIG. 2, the STI-AS 320 of FIG. 3).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for directing an invite message of an emergency call to a first realm, the method comprising:
requesting, by an emergency network function (NF), location information associated with the emergency call;
receiving, by the emergency NF, a modified emergency services routing number (ESRN), wherein the modified ESRN is generated by a location NF modifying an original ESRN to include a traffic path identifier;
based on the traffic path identifier, routing the invite message to the first realm; and
based on routing the invite message to the first realm, waiting, by a routing NF, for an authentication response from an authenticating NF prior to routing the invite message to an authentication-enabled public safety answering point (PSAP).

2. The method of claim 1, wherein, based on an authentication flag, the emergency NF retains one or more authentication headers of the invite message, wherein the authentication flag indicates the invite message is to be routed to the authentication-enabled PSAP, and wherein the authentication response includes an authenticated caller identity token.

3. The method of claim 2, wherein the authenticated caller identity token is a personal assertion token (PASSporT).

4. The method of claim 1, wherein the emergency NF is an emergency call state control function (E-CSCF).

5. The method of claim 1, wherein the location NF is a gateway mobile location center (GLMC).

6. The method of claim 1, wherein the routing NF is a session border controller (SBC).

7. The method of claim 1, wherein the authenticating NF is a secure telephone identity authentication service (STI-AS).

8. The method of claim 1, wherein the traffic path identifier is a prefix of the modified ESRN.

9. A method for directing an invite message of an emergency call to a second realm, the method comprising:
requesting, by an emergency network function (NF), location information associated with the emergency call;
receiving, by the emergency NF, a modified emergency services routing number (ESRN), wherein the modified ESRN is generated by a location NF modifying an original ESRN to include a traffic path identifier;
based on the traffic path identifier, routing the invite message to a second realm; and
based on routing the invite message to the second realm, routing, by a routing NF, the invite message to a non-authentication enabled public safety answering point (PSAP) without waiting for an authentication response from an authenticating NF.

10. The method of claim 9, wherein the traffic path identifier is a prefix of the modified ESRN.

11. The method of claim 10, wherein the emergency NF is an emergency call state control function (E-CSCF).

12. The method of claim 11, wherein the location NF is a gateway mobile location center (GMLC).

13. The method of claim 12, wherein the routing NF is a session border controller (SBC).

14. The method of claim 13, wherein the authenticating NF is a secure telephone identity authentication service (STI-AS).

15. A method for directing an invite message of an emergency call to a first realm or a second realm, the method comprising:
requesting, by an emergency network function (NF), location information associated with the emergency call;
receiving, by the emergency NF, a modified emergency services routing number (ESRN), wherein the modified ESRN is generated by a location NF modifying an original ESRN to include a traffic path identifier; and
based on the traffic path identifier, routing, by a routing NF, the invite message to the first realm or the second realm, wherein the first realm is associated with one or more authentication-enabled public safety answering points (PSAPs) and wherein the second realm is associated with one or more non-authentication-enabled PSAPs.

16. The method of claim 15, wherein the invite message is routed to the first realm based on the traffic path identifier, and wherein in the first realm, the routing NF waits for an authentication response from an authenticating NF.

17. The method of claim 16, wherein, based on an authentication flag, the emergency NF retains one or more authentication headers of the invite message, wherein the authentication flag indicates the invite message is to be routed to an authentication-enabled PSAP of the one or more authentication-enabled PSAPs, and wherein the authentication response comprises an authenticated caller identity token.

18. The method of claim 17, wherein the authenticated caller identity token is a personal assertion token (PASSporT).

19. The method of claim 15, wherein the invite message is routed to the second realm based on the traffic path identifier, and wherein in the second realm, a routing NF routes the invite message to a non-authentication enabled PSAP of the one or more non-authentication-enabled PSAPs without waiting for an authentication response from an authenticating NF.

20. The method of claim 15, wherein the traffic path identifier is a prefix of the modified ESRN.
